(19) United States
(12) Patent Application Publication
(10) Pub. No.: US 2008/0131743 A1
(43) Pub. Date: Jun. 5, 2008

(54) Fuel Cell System and Associated Control Method

(75) Inventors: Nathalie Cornet, Voisins le Brentonneux (FR); Cecile Bernay, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S, Boulogne Billancourt (FR)

(21) Appl. No.: 11/815,283

(22) PCT Filed: Jan. 19, 2006
(86) PCT No.: PCT/FR06/50028

§ 371 Date: Oct. 18, 2007

(30) Foreign Application Priority Data
Feb. 1, 2005 (FR) 0500966

(51) Int. Cl. H01M 8/04

(52) U.S. Cl. 429/17; 429/22

(57) ABSTRACT

A fuel cell system including a mechanism supplying hydrogen to the anode of the cell, a mechanism supplying oxygen to the cathode of the cell, and a control unit. A first control controls the hydrogen supply to the anode of the cell and a second control controls the oxygen supply to the cathode of the cell. A further mechanism determines hydrogen over-stoichiometry in an anodic oxidation half-reaction and a further mechanism determines oxygen over-stoichiometry in a cathodic reduction half-reaction. The first and second controls can adapt hydrogen and oxygen over-stoichiometry of the cell respectively as a function of the required cell power.

The present invention relates to a fuel cell system and to an associated control method.

Fuel cells are used to deliver energy either for stationary applications or in the aeronautical or automobile fields.

Standard fuel cells of the PEM (proton exchange membrane) type comprise individual cells made up in particular from a bipolar plate and an electrode/membrane assembly or MEA.

The electrochemical reactions that take place in the fuel cell make it possible to deliver electrical energy. Such a fuel cell is supplied with hydrogen at the anode, for example via a reformer or a hydrogen tank, and with oxygen at the cathode, generally via an air compressor.

To minimize the consumption of a fuel cell system, and also the carbon dioxide emissions, the aim is to achieve the best possible efficiency of the system. Efficiency optimization of such a system is sought by reducing the power losses generated by the various auxiliary elements and by optimizing the operating efficiency of various members.

More particularly, the efficiency of the system depends directly on the initial choice of operating voltage chosen for maximum power of the fuel cell. In general, the operating voltage chosen for maximum power of the cell is about 0.6 V, by compromising between compactness and cost of the fuel cell.

Condensers are placed at the outlet of the anode and of the cathode of the fuel cell, allowing the gases output by the fuel cell to be condensed. It is important to be able to increase the end-of-condensation temperature downstream of the fuel cell. The term “end-of-condensation temperature” is understood to mean an average temperature representative of the temperatures at the outlet of the anode and cathode condensers located downstream of the fuel cell.

This is because the greater the difference between the end-of-condensation temperature and the temperature of the heat-transfer fluid of the circulation loop of the system, the more the amount of heat that can be absored by the heat-transfer fluid, and the smaller the volume of the condensers can be.

A hydrogen overstoichiometry R_{A} of the anode reduction half-reaction (H₂<2H⁺+2e⁻) and an oxygen overstoichiometry R_{C} of the cathode oxidation half-reaction (½O₂+2H⁺+2e→H₂O) make it possible to get round problems of the overall performance of the cell and of its operating stability.

The term “hydrogen overstoichiometry R_{A}” and the term “oxygen overstoichiometry R_{C}” are understood to mean supplied quantities of reactants above the quantities that would be strictly necessary for the reactions in question (stoichiometry 1).

The overall efficiency of such a fuel cell system is reduced by increasing the hydrogen overstoichiometry of the anode reduction half-reaction and/or the oxygen overstoichiometry of the cathode oxidation half-reaction.

However, there is a limit to how far these overstoichiometries can be lowered, this limit being set by the acceptable performance and the stability of the cell. This is because if these overstoichiometries are too low, certain cell element voltages may drop too much, and even go to voltages of opposite sign, incurring a risk of irreversibly damaging the fuel cell.

U.S. Pat. No. 6,586,123 (UTC Fuel Cells) describes an increase in hydrogen overstoichiometry of the anode reduction half-reaction and oxygen overstoichiometry of the cathode oxidation half-reaction as a function of the current density delivered by the fuel cell above a threshold value of 0.6 A/cm², so as to maintain the performance of the fuel cell at high current densities.

However, for low current densities, the efficiency of the fuel cell and the anode and cathode end-of-condensation temperatures are not optimized.

The term “current density” is understood to mean the local current value per unit of area. The current density corresponds to the current delivered by the fuel cell, divided by the active area of an individual cell element of the fuel cell. The lower the power delivered by the fuel cell, the lower the current density delivered by the fuel cell.

It is an object of the invention to optimize the operation of the fuel cell and the anode and cathode end-of-condensation temperatures for low current densities delivered by the fuel cell.

According to one aspect of the invention, there is proposed a fuel cell system comprising means for supplying hydrogen to the anode of the fuel cell, means for supplying oxygen to the cathode of the fuel cell, and a control unit. The system also includes first control means, for controlling the supply of hydrogen to the anode of the fuel cell, and second control means, for controlling the supply of oxygen to the cathode of the fuel cell. The system further includes first determination means, for determining the hydrogen overstoichiometry of the anode oxidation half-reaction, and second determination means, for determining the oxygen overstoichiometry of the cathode reduction half-reaction. Said first and second control means are capable, respectively, of adapting said hydrogen and oxygen overstoichiometries of the fuel cell according to the power demanded from the fuel cell.

The temperature at the outlet of the condensers located downstream of the fuel cell is therefore higher, thereby making it possible to reduce the volume of the condensers and to improve the efficiency of the system.

Advantageously, the power demanded from the fuel cell is a function of the current density demanded from the fuel cell.

The current density delivered by the cell is a parameter that can be easily manipulated, the power demand passing via a current or current density command.

In a preferred embodiment, said first control means are adapted so as to keep said hydrogen overstoichiometry constant when the current density demanded from the fuel cell is below a first value, and increasing as a function of the current density demanded from the fuel cell when the current density demanded from the fuel cell is above said first value and below a second value greater than said first value. In addition, said second control means are adapted so as to keep said oxygen overstoichiometry constant when the current density demanded from the fuel cell is below said first value, and increasing as a function of the current density demanded from the fuel cell when the current density demanded from the fuel cell is above said first value and below said second value.

The temperature at the outlet of the condensers located downstream of the fuel cell is therefore higher, thereby reducing the volume of the condensers and improving the efficiency of the system.

In one advantageous embodiment, said first determination means comprise first calculation means connected to a first flowmeter placed at the inlet of the anode of the fuel cell and said second determination means comprise second calculation means connected to a second flowmeter placed at the inlet of the cathode of the fuel cell.

It is therefore possible for the flows to the anode and the cathode to be properly controlled, thereby allowing the overstoichiometries to be properly controlled.

In a preferred embodiment, the system includes a sensor for measuring the current delivered by the fuel cell 1.

The corresponding current density is calculated from this current measurement and from the active area of an individual cell element of the fuel cell.

The presence of such a sensor makes it possible to check whether the current density demanded from the fuel cell, and therefore the power demanded from the fuel cell, is indeed delivered downstream of the fuel cell.

In one advantageous embodiment, said first value is approximately equal to 0.2 A/cm² and said second value is approximately equal to 0.6 A/cm².

Furthermore, said first control means are adapted so as to keep said hydrogen overstoichiometry linearly increasing when the current density demanded from the fuel cell is above said first value and below said second value. In addition, said second control means are adapted so as to keep said oxygen overstoichiometry linearly increasing when the current density demanded from the fuel cell is above said second value and below said first value.

According to another aspect of the invention, there is also proposed a method of controlling a fuel cell system, characterized in that the anode of the fuel cell is supplied with hydrogen and the cathode of the fuel cell is supplied with oxygen so as to adapt the hydrogen overstoichiometry of the anode oxidation half-reaction and the oxygen overstoichiometry of the cathode reduction half-reaction, respectively, as a function of the power demanded from the fuel cell.

In a preferred implementation, the power demanded from the fuel cell is a function of the current density demanded from the fuel cell.

In an advantageous implementation, said hydrogen overstoichiometry is kept constant when the current density demanded from the fuel cell is below a first value, and increasing as a function of the current density demanded from the fuel cell when the current density demanded from the fuel cell is above said first value and below a second value. Furthermore, said oxygen overstoichiometry is kept constant when the current density demanded from the fuel cell is below said first value, and increasing as a function of the current density demanded from the fuel cell when the current density demanded from the fuel cell is above said first value and below said second value.

Other objects, features and advantages of the invention will become apparent on reading the following description of a few nonlimiting examples, and with reference to the appended drawings in which:

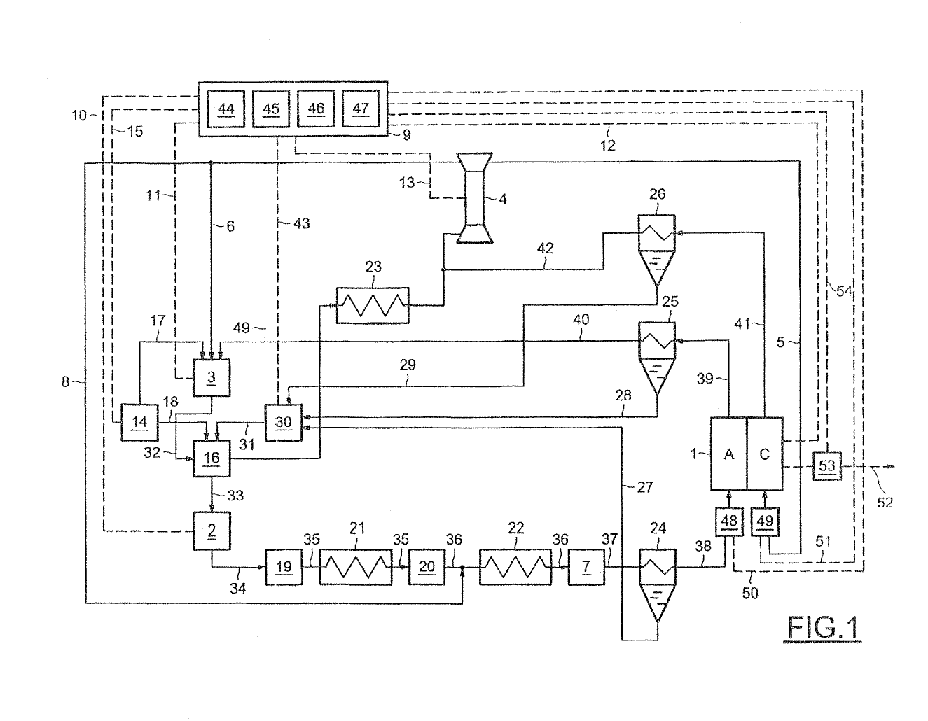

FIG. 1 is a block diagram of a system according to one aspect of the invention;

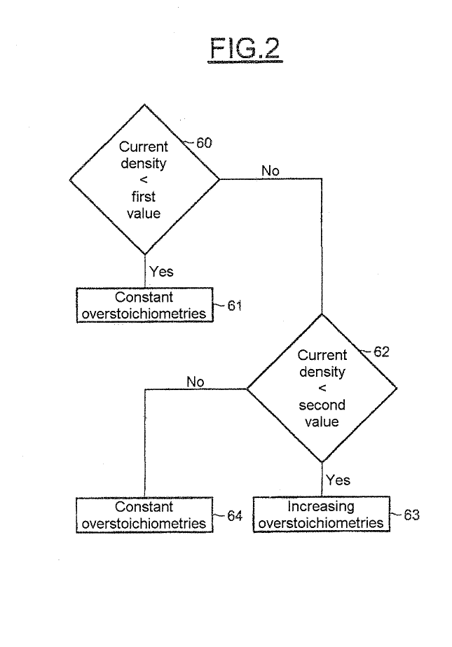

FIG. 2 illustrates a method according to one aspect of the invention; and

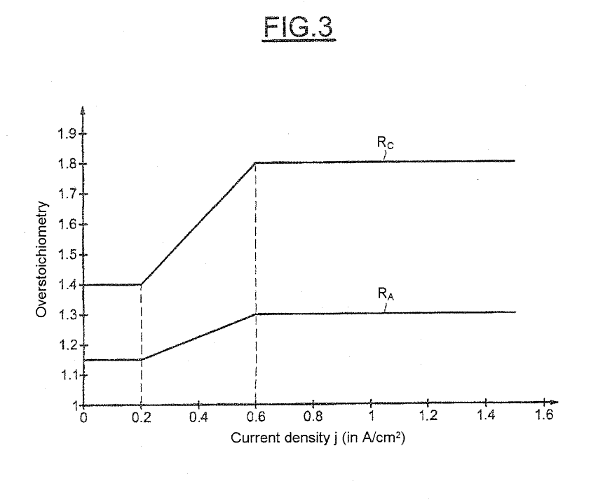

FIG. 3 illustrates adaptations of the anode and cathode overstoichiometries according to one aspect of the invention.

FIG. 1 shows a system according to the invention, on board a motor vehicle. The system includes a fuel cell 1, comprising an anode part A and a cathode part C, and a reformer 2 for supplying the fuel cell 1 with hydrogen. The system also includes a burner 3 for heating the entire system during the startup phase and for regulating the temperature during nominal operation. The fuel cell 1 is designed so that the voltage chosen for maximum power is 0.7 V. The burner 3 also provides the energy needed for the reforming reaction and enables hydrogen to be oxidized when it uses a return for the gases output by the anode of the fuel cell 1. The burner 3 also makes it possible to provide the energy needed to vaporize the water and the fuel that are necessary for the reformer 2.

The system also includes an air compressor 4 which supplies oxygen, generally in the form of compressed air, to the fuel cell 1 and to the burner 3, via lines 5 and 6 respectively. The air compressor 4 also supplies a preferential oxidation reactor 7 with air via a line 8. The system further includes an electronic control unit 9, which is also used for other purposes such as for controlling the stability of the vehicle or braking, said control unit being connected to the reformer 2, to the burner 3, to the fuel cell 1 and to the air compressor 4 via connections 10, 11, 12 and 13 respectively.

The system also includes a fuel supply device 14, comprising a fuel tank connected to the electronic control unit 9 via a connection 15. This fuel supply device 14 supplies fuel to the burner 3 and to a vaporizer 16, which vaporizes the water and the fuel upstream of the reformer 2. The burner 3 and the vaporizer 16 are supplied with fuel via lines 17 and 18 respectively. Downstream of the reformer 2 are two gas-to-water reaction reactors 19 and 20 operating at high temperature and low temperature respectively. These two reactors 19 and 20, together with the preferential oxidation reactor 7, make it possible for the carbon monoxide (CO) content of the reformate supplying the fuel cell 1 to be greatly reduced, since CO poisons fuel cells. Various heat exchangers 21, 22 and 23 are present in order to cool gas streams. The system also includes various condensers 24, 25 and 26 for recovering water and sending it, via lines 27, 28 and 29 respectively, into a water supply device 30, comprising a water tank, in particular for supplying the vaporizer 16 with water via a line 31. The gases output by the burner 3 are sent to the vaporizer 16 via a line 32 for delivering the energy needed to vaporize the water and the fuel that are supplied to the reformer 2 via a line 33. The reformate is then taken in succession to the reactors 19, 20 and 7, to be greatly depleted of carbon monoxide via lines 34, 35 and 36. Finally, the reformate, output by the preferential oxidation reactor 7, is taken to the condenser 24 via a line 37. The reformate output by the condenser 24 then feeds the anode part A of the fuel cell 1 via a line 38.

The gases output by the anode A are taken to the condenser 25 via a line 39. The gases output by the condenser 25 then supply the burner 3 via a line 40. The gases output by the cathode part C of the fuel cell 1 are taken to the condenser 26 via a line 41, before being mixed, via a line 42, with the gases output by the exchanger 23. The mixture is then taken to the turbine 4. The water supply device 30 is also controlled by the electronic control unit 9 via a connection 43.

The electronic control unit 9 comprises a first control module 44, for controlling the hydrogen supply in the cell, for example by acting on the reformer 2, and a second control module 45, for controlling the supply of oxygen to the cathode of the fuel cell, for example by acting on the air compressor 4.

The electronic control control unit 9 further includes a first determination module 46, for determining the hydrogen overstoichiometry R_{A} of the anode oxidation half-reaction, and a second determination module 47, for determining the oxygen overstoichiometry R_{C} of the cathode reduction half-reaction. The first and second modules 46 and 47 determine the respective overstoichiometries R_{A} and R_{C} as a function of the various flow rates of the gases supplying the cell 1, delivered for example by respective flowmeters 48 and 49. The flowmeter 48 is located at the hydrogen supply inlet of the anode A of the fuel cell 1 and the flowmeter 49 si located at the oxygen supply inlet of the cathode C of the fuel cell 1. The flowmeters 48 and 49 are connected to the electronic control unit 9 via connections 50 and 51 respectively. Furthermore, the electrical energy delivered by the fuel cell, via an output cable 52, is measured by a current sensor 53 connected to the electronic unit control unit 9 via a connection 54. The electronic control unit calculates the current density corresponding to the current delivered by the sensor 53.

A method according to one aspect of the invention is described in FIG. 2. The power demanded from the fuel cell 1 is for example a function of the current density demanded from the fuel cell 1. The first and second control means 44 and 45 test (step 60) whether the current density demanded from the fuel cell 1 is below the first value.

If the current density demanded from the fuel cell 1 is below the first value, the first and second control means 44 and 45 keep the overstoichiometries R_{A} and R_{C} constant as a function of the current density demanded from the fuel cell 1 (step 61).

If the current density demanded from the fuel cell 1 is equal to or above the first value, the first and second control means 44 and 45 test (step 62) whether the current density demanded from the fuel cell 1 is below the second value.

If the current density demanded from the fuel cell 1 is equal to or above the first value and below the second value, the first and second control means 44 and 45 keep the overstoichiometries R_{A} and R_{C} increasing as a function of the current density demanded from the fuel cell 1 (step 63).

If the current density demanded from the fuel cell 1 is equal to or above the second value, the first and second control means 44 and 45 keep the overstoichiometries R_{A} and R_{C} constant as a function of the current density demanded from the fuel cell 1 (step 64).

Conventionally, the hydrogen overstoichiometry R_{A} of the anode oxidation half-reaction has a value of 1.30 and the oxygen overstoichiometry R_{C} of the cathode reduction half-reaction has a value of 1.8.

The invention makes it possible to adapt the respective overstoichiometries R_{A} and R_{C} according to the current density delivered by the fuel cell 1.

An example of such overstoichiometry adaptation as a function of the current density demanded from the fuel cell is illustrated in FIG. 3.

In this example, the first current density value is 0.2 A/cm² and the second current density value is 0.6 A/cm².

For current density values between 0 and 0.2 A/cm², the overstoichiometries R_{A} and R_{C} are kept constant as a function of the current density demanded from the fuel cell 1 (step 61) with the following values: R_{A}=1.15 A/cm² and R_{C}=1.4 A/cm².

For current density values between 0.2 and 0.6 A/cm², the overstoichiometries R_{A} and R_{C} are kept increasing as a function of the current density demanded from the fuel cell 1 (step 63), here linearly increasing as a function of the current density demanded from the fuel cell 1, with respective equations R_{A}=0.375j+1.075 and R_{C}=j+1.2, in which j represents the variable corresponding to the current density demanded from the fuel cell 1.

Finally, for current density values greater than 0.6 A/cm², the overstoichiometries R_{A} and R_{C} are kept constant as a function of the current density demanded from the fuel cell 1 (step 64), with respective values: R_{A}=1.3 A/cm² and R_{C}=1.8 A/cm².

In such a system, the burner 3 is only supplied with gases coming from the anode outlet of the fuel cell 1 or, if the reformer 2 requires more thermal energy, the burner 3 may furthermore be supplied with fuel. The expression for the efficiency of the system therefore varies according to the supply to the burner 3.

The invention makes it possible to increase the efficiency of the fuel cell system by about 2 to 5% and to reduce the consumption of the air supply device of the fuel cell system by 2 to 4%, for a low cell power demand.

Furthermore, the end-of-condensation temperature is increased by 4 to 8° C., thereby making it possible to reduce the volume of the condensers downstream of the fuel cell.

1-10. (canceled)

11. A fuel cell system comprising:
means for supplying hydrogen to an anode of the fuel cell;
means for supplying oxygen to a cathode of the fuel cell;
a control unit;
first control means for controlling the supply of hydrogen to the anode of the fuel cell;
second control means for controlling the supply of oxygen to the cathode of the fuel cell;
first determination means for determining hydrogen overstoichiometry of the anode oxidation half-reaction; and
second determination means for determining oxygen overstoichiometry of the cathode reduction half-reaction;
wherein the first and second control means can respectively, adapt the hydrogen and oxygen overstoichiometries of the cell according to power demanded from the fuel cell.

12. The system as claimed in claim 11, wherein the power demanded from the fuel cell is a function of a current density demanded from the fuel cell.

13. The system as claimed in claim 12, wherein:
said first control means is configured to keep the hydrogen overstoichiometry constant when the current density demanded from the fuel cell is below a first value, and increases as a function of the current density demanded from the fuel cell when the current density demanded from the fuel cell is above the first value and below a second value greater than the first value; and
said second control means is configured to keep the oxygen overstoichiometry constant when the current density demanded from the fuel cell is below the first value, and increases as a function of the current density demanded from the fuel cell when the current density demanded from the fuel cell is above the first value and below the second value.

14. The system as claimed in claim 11, wherein said first determination means comprises first calculation means connected to a first flowmeter placed at an inlet of the anode of the fuel cell, and said second determination means comprises second calculation means connected to a second flowmeter placed at an inlet of the cathode of the fuel cell.

15. The system as claimed in claim 11, further comprising a sensor configured to measure the current delivered by the fuel cell.

16. The system as claimed in claim 13, wherein the first value is approximately equal to 0.2 A/cm² and the second value is approximately equal to 0.6 A/cm².

17. The system as claimed in claim 13, wherein:
said first control means is configured to keep the hydrogen overstoichiometry linearly increasing when the current density demanded from the fuel cell is above the first value and below the second value; and
said second control means is configured to keep the oxygen overstoichiometry linearly increasing when the current density demanded from the fuel cell is above the second value and below the first value.

18. A method of controlling a fuel cell system, wherein an anode of the fuel cell is supplied with hydrogen and a cathode of the fuel cell is supplied with oxygen so as to adapt hydrogen overstoichiometry of the anode oxidation half-reaction and oxygen overstoichiometry of the cathode reduction half-reaction, respectively, as a function of power demanded from the fuel cell.

19. The method as claimed in claim 18, wherein the power demanded from the fuel cell is a function of a current density demanded from the fuel cell.

20. The method as claimed in claim 19, wherein the hydrogen overstoichiometry is kept constant when the current density demanded from the fuel cell is below a first value, and increases as a function of the current density demanded from the fuel cell when the current density demanded from the fuel cell is above the first value and below a second value, and wherein the oxygen overstoichiometry is kept constant when the current density demanded from the fuel cell is below the first value, and increases as a function of the current density demanded from the fuel cell when the current density demanded from the fuel cell is above the first value and below the second value.
